(19) United States
(12) Patent Application Publication
(10) Pub. No.: US 2017/0278222 A1
(43) Pub. Date: Sep. 28, 2017

(54) METHOD AND ELECTRONIC DEVICE FOR ELEMENT DISPLAYING

(71) Applicants: Le Holdings (Beijing) Co., Ltd., Beijing (CN); LE SHI INTERNET INFORMATION & TECHNOLOGY CORP., BEIJING, BEIJING (CN)

(72) Inventor: Fengyang AN, Beijing (CN)

(21) Appl. No.: 15/246,817

(22) Filed: Aug. 25, 2016

Related U.S. Application Data
(63) Continuation of application No. PCT/CN2016/089174, filed on Jul. 7, 2016.

(30) Foreign Application Priority Data
Mar. 22, 2016 (CN) 201610166642.8

(51) Int. Cl. G06T 5/00; G06T 11/20; G06F 3/0481; G06T 13/80

(52) U.S. Cl. CPC G06T 5/002; G06T 13/80; G06T 11/206; G06F 3/0481; G06T 2200/24

(57) ABSTRACT

A method for element displaying is disclosed. The method includes: at an intelligent terminal, when an interface switching instruction is received by the intelligent terminal in a state where elements are displayed in a background view, beginning to calculate elements to be displayed after the switching; prior to element generation, taking the background view prior to the switching as a sample to calculate, so as to obtain an element background similar to the background view prior to the switching through element complex calculation; displaying the element background similar to the background view prior to the switching; concealing an element displaying control; calling back the element displaying control; and displaying the elements to be displayed after the switching when calculation of the element to be displayed after the switching is completed.

The present disclosure is a continuation application of International patent application No. PCT/CN2016/089174, filed on Jul. 7, 2016, which claims priority to Chinese Patent Application No. 201610166642.8, filed with the Chinese Patent Office on Mar. 22, 2016, both of which are herein incorporated by reference in their entireties.

### TECHNICAL FIELD

The present disclosure relates to the field of vehicle-mounted intelligent terminal displaying, and particularly, to a method and an electronic device for element displaying.

### BACKGROUND

In the related arts, vehicle-mounted intelligent terminals support touch control. Because hardware used in vehicle-mounted intelligent terminals needs to have stability under extreme environments, the hardware performance thereof is inferior to that of consumer intelligent terminals by at least two generations. To implement relatively complex software on a low-performance equipment, performance optimization is critical.

To achieve a user interface that is relatively pleasant to the eyes, some special interface elements are required sometimes to present special displaying effects. To present these special displaying effects, complex calculation is necessary. These interface elements that require complex calculation are referred to as “complex calculation interface elements” and called as “elements” for short in the present disclosure.

When tens of elements need to be displayed at the same time in certain interfaces, the elements outside a touch screen should be displayed within an extremely short time in the interfaces when a user drags the interfaces on the touch screen.

### SUMMARY

A method for element displaying is provided in an embodiment of the present disclosure.

The method includes:

at an electronic device;

when an interface switching instruction is received in a state where elements are displayed in a background view, beginning to calculate elements to be displayed after the switching;

prior to element generation, taking the background view prior to the switching as a sample to calculate, so as to obtain an element background similar to the background view prior to the switching through element complex calculation;

displaying the element background similar to the background view prior to the switching; concealing an element displaying control; and

calling back the element displaying control and displaying the elements to be displayed after the switching when calculation of the element to be displayed after the switching is completed.

An electronic device is provided in another embodiment of the present disclosure. The electronic device includes: at least one processor and a storage device. The storage device is communicably connected with the at least one processor for storing instructions executable by the at least one processor. wherein execution of the instructions by the at least one processor causes the at least one processor to:

when an interface switching instruction is received in a state where elements are displayed in a background view, begin to calculate elements to be displayed after the switching;

prior to element generation, take the background view prior to the switching as a sample to calculate, so as to obtain an element background similar to the background view prior to the switching through element complex calculation;

display the element background similar to the background view prior to the switching;

conceal an element displaying control;

call back the element displaying control; and

display the elements to be displayed after the switching when calculation of the element to be displayed after the switching is completed.

A non-transitory computed readable storage medium for element displaying is provided in still another embodiment of the present disclosure. The non-transitory computed readable storage medium stores executable instructions. wherein when the executable instructions are executed by at least one processor causes the at least one processor to:

when an interface switching instruction is received in a state where elements are displayed in a background view, begin to calculate elements to be displayed after the switching;

prior to element generation, take the background view prior to the switching as a sample to calculate, so as to obtain an element background similar to the background view prior to the switching through element complex calculation;

display the element background similar to the background view prior to the switching;

conceal an element displaying control;

call back the element displaying control; and

display the elements to be displayed after the switching when calculation of the element to be displayed after the switching is completed.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart diagram of an embodiment of a method for element displaying according to the present disclosure.

FIG. 2 is a schematic view of an embodiment of a device for element displaying according to the present disclosure.

FIG. 3 is a schematic view of an embodiment of an intelligent terminal according to the present disclosure.

### DETAILED DESCRIPTION

To make the objective, technical solutions and advantages of the present disclosure clearer, the present disclosure will be further detailed with reference to embodiments thereof and the attached drawings.

It shall be appreciated that, all expressions employing terms such as “the first” and “the second” as used in the embodiments of the present disclosure are intended to distinguish two entities or parameters which have the same name but actually are different from each other. Therefore, the terms such as “the first” and “the second” are only for convenience of description and should not be construed as being limiting to the embodiments of the present disclosure, and this will not be further described for the subsequent embodiments.

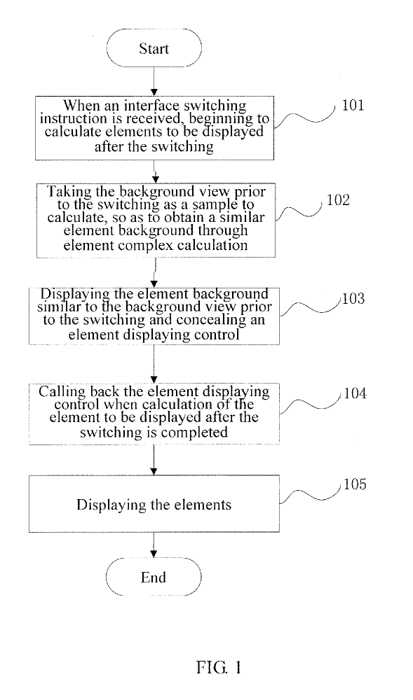

As shown in FIG. 1, a flowchart diagram of an embodiment of a method for element displaying according to the present disclosure includes the following steps.

In Step 101: when an interface switching instruction is received in a state where elements are displayed on an intelligent terminal, beginning to calculate elements to be displayed after the switching. The interface switching instruction may be a touch operation of a user, and may also be an operation on a key outside the display screen of the intelligent terminal.

In step 102: prior to element generation, taking the background view prior to the switching as a sample to calculate, so as to obtain an element background similar to the background view prior to the switching through element complex calculation. In this way, a transition stage is provided for element displaying, and the time for which the element is displayed is prolonged without affecting the visual experience of the user.

In step 103: displaying the element background similar to the background view prior to the switching and concealing an element displaying control. After the element displaying control is concealed, a larger memory space is provided for the element complex calculation and the operating speed is increased.

In step 104: calling back the element displaying control when calculation of the element to be displayed after the switching is completed.

In step 105: displaying the elements on the interface.

In some embodiments, the elements are interface elements that achieve special displaying effects after some complex calculation.

As an embodiment of the present disclosure, the element complex calculation process includes: adjusting color values of pixels by use of the Gaussian blurring algorithm and according to the Gaussian curve, performing image blurring on the elements to be displayed for a plurality of times and displaying the elements to be displayed that have been image blurred in the forms of tweening animations in an ascending order of definition.

The formula of the aforesaid Gaussian blurring algorithm is:

$$G ( x , y ) = \frac{1}{2 {πσ}^{2}} {e}^{- ( {x}^{2} + {y}^{2} ) / 2 {σ}^{2}} ,$$

wherein x, y are the horizontal coordinate and the vertical coordinate of the pixel point respectively, and σ is a constant.

The aforesaid process of performing image blurring on the elements to be displayed for a plurality of times and displaying the elements to be displayed that have been image blurred in the forms of tweening animations in an ascending order of definition includes:

performing Gaussian blurring on the three RGB channels of the elements to be displayed, and for each channel of a single color, blurring radii are set in a descending order of the blurring radii to calculate a Gaussian blurring value of each pixel point of the elements to be displayed, assigning the resulting Gaussian blurring value to each pixel point, and displaying the pixel point with the assigned value to obtain the element to be displayed;

for each blurring radius, choosing a pixel point from the element to be displayed as a central point, taking eight pixel points closest to the chosen pixel point within the blurring radius, setting the value of σ, substituting the coordinates of the aforesaid eight pixel points into the Gaussian blurring algorithm formula to obtain weight values corresponding to the eight pixel points, multiplying the weight values of the eight pixel points with grayscale values corresponding to the eight pixel points to obtain final weight values, and summing up the final weigh values to obtain the Gaussian blurring value of the chosen pixel point; and

repeating the aforesaid process for all the pixel points to obtain the Gaussian blurring value of each of the pixel points, assigning the resulting Gaussian blurring value to each of the pixel points and displaying the pixel points with the assigned values to obtain the element to be displayed.

The process of assigning the resulting Gaussian blurring value to each of the elements includes: importing the resulting Gaussian blurring value into a static array; calculating the number of the elements to be displayed in the newly created background; calculating a maximum value of a horizontal scroll; importing Gaussian blurring values corresponding to the number of the elements to be displayed among the imported Gaussian blurring values into a dynamic array starting from a start position of the imported Gaussian blurring values that corresponds to a preset initial value of the horizontal scroll; assigning data in the dynamic array to a chart control to form a chart; converting the current chart into elements; and displaying the elements in the background.

In the aforesaid embodiments, if only one blurring radius is chosen, then the process of displaying the elements in the forms of tweening animations in the method of the present disclosure includes three stages: in the first stage, an element background similar to the background view prior to the switching is displayed; in the second stage, the element image that has been processed by Gaussian blurring within the blurring radium is displayed; and in the third stage, the element displaying control is called back to display the elements finally in the clear state. Similarly, if two blurring radii are chosen, then the aforesaid second stage includes the element images that have been processed by Gaussian blurring at two stages, but the element interface gradually becomes clear on the whole.

As another embodiment of the present disclosure, the interface elements on the intelligent terminal are recovered when the elements are in an invisible or covered state, thereby providing a larger operating memory for the element complex calculation and the generation of the image.

As yet another embodiment of the present disclosure, before calling back the element displaying control, the method further includes:

snooping the time needed to generate the background through the element complex calculation, and calling back the element displaying control when the time needed to generate the background elapses.

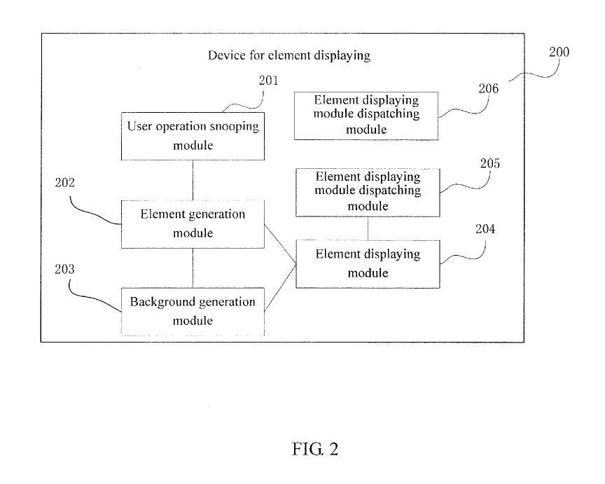

FIG. 2 is a schematic view of an embodiment of a device 200 for element displaying according to the present disclosure. The device 200 for element displaying includes: a user operation snooping module 201, an element generation module 202, a background generation module 203, an element displaying module 204, and an element displaying module dispatching module 205.

The user operation snooping module 201 is configured to snoop an interface switching instruction transmitted by a user. The interface switching instruction may be a touch operation of a user, and may also be an operation on a key outside the display screen of the intelligent terminal.

The element generation module 202 is configured to calculate and generate elements. The process of calculating and generating elements may include one stage or may include several stages. When the process includes one stage, the displaying process includes displaying an element background similar to the background view prior to the switching and displaying the interface elements after the interface switching. When the process includes several stages, the element background similar to the background view prior to the switching and the interface elements after the interface switching are displayed at the first stage of the process, and the interface elements after the interface switching are displayed in the forms of tweening animations in an ascending order of definition at the following stages of the process. Because the process provides buffering time for the displaying of interface elements, the drawback that elements popping into the screen cannot be displayed in time due to the complex calculation is avoided and meanwhile good visual experience is provided to the users.

The background generation module 203 is configured to, prior to element generation, take the background view prior to the switching as a sample to calculate, so as to obtain an element background similar to the background view prior to the switching through element complex calculation and display the resulting element background. The element background is a middle state during the transition of the background view prior to the switching to the element interface generated after the switching, i.e., the grayscale value of a certain pixel point in the element background is between the grayscale value of the pixel point in the background view prior to the switching and the grayscale value of the pixel point in the element interface after the switching.

The element displaying module 204 includes an element displaying control which is configured to display the elements generated by the element complex calculation and also configured to recover the elements which are in an invisible or covered state.

The element displaying module dispatching module 205 is configured to conceal and call back the element displaying module 204.

In some embodiments, the elements are interface elements that achieve special displaying effects after some complex calculation.

As an embodiment of the device 200 according to the present disclosure, the element complex calculation process includes: the element generation module adjusts color values of pixels by use of the Gaussian blurring algorithm and according to the Gaussian curve, performs image blurring on the elements to be displayed for a plurality of times and displays the elements to be displayed that have been image blurred in the forms of tweening animations in an ascending order of definition.

The formula of the aforesaid Gaussian blurring algorithm is:

$$G ( x , y ) = \frac{1}{2 {πσ}^{2}} {e}^{- ( {x}^{2} + {y}^{2} ) / 2 {σ}^{2}} ,$$

wherein x, y arc the horizontal coordinate and the vertical coordinate of the pixel point respectively, and σ is a constant.

The aforesaid process of performing image blurring on the elements to be displayed for a plurality of times and displaying the elements to be displayed that have been image blurred in the forms of tweening animations in an ascending order of definition by the element displaying module includes:

performing Gaussian blurring on the three RGB channels of the elements to be displayed, and for each channel of a single color, blurring radii are set in a descending order of the blurring radii to calculate a Gaussian blurring value of each pixel point of the elements to be displayed, assigning the resulting Gaussian blurring value to each pixel point, and displaying the pixel point with the assigned value to obtain the element to be displayed;

for each blurring radius, choosing a pixel point from the element to be displayed as a central point, taking eight pixel points closest to the chosen pixel point within the blurring radius, setting the value of 6, substituting the coordinates of the aforesaid eight pixel points into the Gaussian blurring algorithm formula to obtain weight values corresponding to the eight pixel points, multiplying the weight values of the eight pixel points with grayscale values corresponding to the eight pixel points to obtain final weight values, and summing up the final weigh values to obtain the Gaussian blurring value of the chosen pixel point; and

repeating the aforesaid process for all the pixel points to obtain the Gaussian blurring value of each of the pixel points, assigning the resulting Gaussian blurring value to each of the pixel points and displaying the pixel points with the assigned values to obtain the element to be displayed.

The process of assigning the resulting Gaussian blurring value to each of the elements by the element generation module 202 includes: importing the resulting Gaussian blurring value into a static array; calculating the number of the elements to be displayed in the newly created background; calculating a maximum value of a horizontal scroll; importing Gaussian blurring values corresponding to the number of the elements to be displayed among the imported Gaussian blurring values into a dynamic array starting from a start position of the imported Gaussian blurring values that corresponds to a preset initial value of the horizontal scroll; assigning data in the dynamic array to a chart control to form a chart; converting the current chart into elements; and displaying the aforesaid elements in the background by the element displaying control in the element displaying module 204.

In the embodiment, if only one blurring radius is chosen, then the process of displaying the elements in the forms of tweening animations includes three stages: in the first stage, an element background similar to the background view prior to the switching is displayed; in the second stage, the element image that has been processed by Gaussian blurring within the blurring radium is displayed; and in the third stage, the element displaying control is called back to display the elements finally in the clear state. Similarly, if two blurring radii are chosen, then the aforesaid second stage includes the element images that have been processed by Gaussian blurring at two stages, but the element interface gradually becomes clear on the whole.

As another embodiment of the present disclosure, the interface elements on the intelligent terminal are recovered by the element displaying module 204 when the elements are in an invisible or covered state, thereby providing a larger operating memory for the element complex calculation and the generation of the image in the element generation module 202.

As yet another embodiment of the present disclosure, the device 200 further includes: a time snooping module 206, configured to, before calling back the element displaying control, snoop the time needed to generate the background through the element complex calculation, and call back the element displaying module 204 by the element displaying module dispatching module 205 when the time needed to generate the background elapses, and display the elements by the element displaying control in the element displaying module 204.

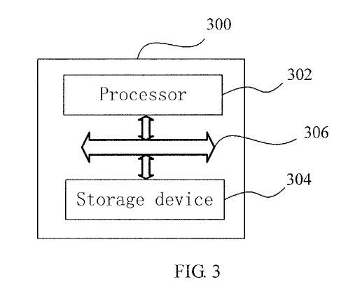

FIG. 3 is a schematic view of an embodiment of an intelligent terminal 300 according to the present disclosure. The intelligent terminal 300 includes: a processor 302, a storage device 304, and a bus system 306. The processor 302 and the storage device 304 are connected to each other via the bus system 306, the storage device 304 is configured to store program instructions, and the processor 302 is configured to execute the program instructions stored in the storage device 304.

The storage device 304 may be a non-transitory computed readable storage medium, which is configured to store computed executable program instructions. When the program instructions are executed by one or more central processors, for example, the processor 302 may be caused to perform the steps in the above mentioned embodiments of the method, for example, steps 101 to 105 illustrated in FIG. 1. The computed executable program instructions may also be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

In some embodiments, the device 200 of FIG. 2, as mentioned above, may be a computed software program device, the modules 201-206 are computed software program modules, stored in the storage device 304, and executed by the processor 302 to achieve the function of each module when in working.

It should be understood that in the embodiments of the present application, the processor 302 may be a central processing unit (CPU). The processor 302 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 306 may further includes a power bus, a control bus, a state signal bus and the like. However, for clarity of description, various buses are all marked as the bus system 306.

In the embodiments of the present invention, the intelligent terminal 300 is not limited to the components and configurations as illustrated in FIG. 3, but may further include other or additional components having a plurality of configurations.

During the implementation, various steps in the above method and various modules in the above device 200 may be implemented by means of an integrated logic circuit in the processor 302 or by means of software. The steps in the method and the modules in the device 200 disclosed in the embodiments of the present invention may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the storage device 304. The processor 302 reads the information stored in the storage device 304 and performs the steps of the above method in combination with the hardware thereof. For brevity of description, the details are not given herein any further.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the method may be achieved in any sequence, and there are many other variations in different aspects of the present disclosure described above, although they are not detailed for purpose of simplicity.

Embodiments of the present disclosure are intended to cover all such replacements, modifications and variations falling within the broad scope of the attached claims. Accordingly, any omissions, modifications, equivalent replacements, and alterations within the spirits and principles of the present disclosure shall be included in the scope of the present disclosure.

What is claimed is:

1. A method for element displaying, comprising:
at an electronic device;
when an interface switching instruction is received in a state where elements are displayed in a background view, beginning to calculate elements to be displayed after the switching;
prior to element generation, taking the background view prior to the switching as a sample to calculate, so as to obtain an element background similar to the background view prior to the switching through element complex calculation;
displaying the element background similar to the background view prior to the switching;
concealing an element displaying control;
calling back the element displaying control; and
displaying the elements to be displayed after the switching when calculation of the element to be displayed after the switching is completed.

2. The method according to claim 1, wherein the element complex calculation comprises:
adjusting color values of pixels by use of the Gaussian blurring algorithm and according to the Gaussian curve;
performing image blurring on the elements to be displayed for a plurality of times; and
displaying the elements to be displayed that have been image blurred in the forms of tweening animations in an ascending order of definition.

3. The method according to claim 2, wherein performing image blurring on the elements to be displayed for a plurality of times and displaying the elements to be displayed that have been image blurred in the forms of tweening animations in an ascending order of definition comprises:
performing Gaussian blurring on the three RGB channels of the elements to be displayed, wherein for each channel of a single color, setting blurring radii in a descending order of the blurring radii to calculate a Gaussian blurring value of each pixel point of the elements to be displayed, assigning the resulting Gaussian blurring value to each pixel point, and displaying the pixel point with the assigned value to obtain the element to be displayed;
for each blurring radius, choosing a pixel point from the element to be displayed as a central point, taking eight pixel points closest to the chosen pixel point within the blurring radius, obtaining weight values corresponding to the eight pixel points by use of the Gaussian blurring algorithm, multiplying the weight values of the eight pixel points with grayscale values corresponding to the eight pixel points to obtain final weight values, and summing up the final weigh values to obtain the Gaussian blurring value of the chosen pixel point; and
repeating the aforesaid process for all the pixel points to obtain the Gaussian blurring value of each of the pixel points, assigning the resulting Gaussian blurring value to each of the pixel points and displaying the pixel points with the assigned values to obtain the element to be displayed.

4. The method according to claim 3, wherein assigning the resulting Gaussian blurring value to each of the pixel points and displaying the pixel points with the assigned values comprises:
importing the resulting Gaussian blurring value into a static array;
calculating the number of the elements to be displayed in the newly created background;
importing Gaussian blurring values corresponding to the number of the elements to be displayed among the imported Gaussian blurring values into a dynamic array starting from a start position of the imported Gaussian blurring values that corresponds to a preset initial value of a horizontal scroll;
assigning data in the dynamic array to a chart control to form a chart;
converting the current chart into elements; and
displaying the elements in the background.

5. The method according to claim 1, further comprising: recovering the elements when the elements are in an invisible or covered state.

6. The method according to claim 1, before calling back the element displaying control, further comprising:
snooping the time needed to generate the background through the element complex calculation; and
calling back the element displaying control when the time needed to generate the background elapses.

7. An electronic device, comprising:
at least one processor; and
a storage device communicably connected with the at least one processor for storing instructions executable by the at least one processor, wherein execution of the instructions by the at least one processor causes the at least one processor to:
when an interface switching instruction is received in a state where elements are displayed in a background view, begin to calculate elements to be displayed after the switching;
prior to element generation, take the background view prior to the switching as a sample to calculate, so as to obtain an clement background similar to the background view prior to the switching through clement complex calculation;
display the element background similar to the background view prior to the switching;
conceal an element displaying control;
call back the element displaying control; and
display the elements to be displayed after the switching when calculation of the element to be displayed after the switching is completed.

8. The electronic device according to claim 7, wherein the element complex calculation comprises:
adjusting color values of pixels by use of the Gaussian blurring algorithm and according to the Gaussian curve;
performing image blurring on the elements to be displayed for a plurality of times; and
displaying the elements to be displayed that have been image blurred in the forms of tweening animations in an ascending order of definition.

9. The electronic device according to claim 8, wherein performing image blurring on the elements to be displayed for a plurality of times and displaying the elements to be displayed that have been image blurred in the forms of tweening animations in an ascending order of definition comprises:
performing Gaussian blurring on the three RGB channels of the elements to be displayed, wherein for each channel of a single color, setting blurring radii in a descending order of the blurring radii to calculate a Gaussian blurring value of each pixel point of the elements to be displayed, assigning the resulting Gaussian blurring value to each pixel point, and displaying the pixel point with the assigned value to obtain the element to be displayed;
for each blurring radius, choosing a pixel point from the element to be displayed as a central point, taking eight pixel points closest to the chosen pixel point within the blurring radius, obtaining weight values corresponding to the eight pixel points by use of the Gaussian blurring algorithm, multiplying the weight values of the eight pixel points with grayscale values corresponding to the eight pixel points to obtain final weight values, and summing up the final weigh values to obtain the Gaussian blurring value of the chosen pixel point; and
repeating the aforesaid process for all the pixel points to obtain the Gaussian blurring value of each of the pixel points, assigning the resulting Gaussian blurring value to each of the pixel points and displaying the pixel points with the assigned values to obtain the element to be displayed.

10. The electronic device according to claim 9, wherein assigning the resulting Gaussian blurring value to each of the pixel points and displaying the pixel points with the assigned values comprises:
importing the resulting Gaussian blurring value into a static array;
calculating the number of the elements to be displayed in the newly created background;
importing Gaussian blurring values corresponding to the number of the elements to be displayed among the imported Gaussian blurring values into a dynamic array starting from a start position of the imported Gaussian blurring values that corresponds to a preset initial value of a horizontal scroll;
assigning data in the dynamic array to a chart control to form a chart;
converting the current chart into elements; and
displaying the elements in the background.

11. The electronic device according to claim 7, wherein execution of the instructions by the at least one processor further causes the at least one processor to: recover the elements when the elements are in an invisible or covered state.

12. The electronic device according to claim 7, wherein before calling back the element displaying control, execution of the instructions by the at least one processor further causes the at least one processor to:
snoop the time needed to generate the background through the element complex calculation; and
call back the element displaying control when the time needed to generate the background elapses.

13. A non-transitory computed readable storage medium storing executable instructions, wherein when the executable instructions are executed by at least one processor causes the at least one processor to:
when an interface switching instruction is received in a state where elements are displayed in a background view, begin to calculate elements to be displayed after the switching;
prior to element generation, take the background view prior to the switching as a sample to calculate, so as to obtain an element background similar to the background view prior to the switching through element complex calculation;
display the element background similar to the background view prior to the switching;
conceal an element displaying control;
call back the element displaying control; and
display the elements to be displayed after the switching when calculation of the element to be displayed after the switching is completed.

14. The non-transitory computed readable storage medium according to claim 13, wherein the element complex calculation comprises:
adjusting color values of pixels by use of the Gaussian blurring algorithm and according to the Gaussian curve;
performing image blurring on the elements to be displayed for a plurality of times; and
displaying the elements to be displayed that have been image blurred in the forms of tweening animations in an ascending order of definition.

15. The non-transitory computed readable storage medium according to claim 14, wherein performing image blurring on the elements to be displayed for a plurality of times and displaying the elements to be displayed that have been image blurred in the forms of tweening animations in an ascending order of definition comprises:
performing Gaussian blurring on the three RGB channels of the elements to be displayed, wherein for each channel of a single color, setting blurring radii in a descending order of the blurring radii to calculate a Gaussian blurring value of each pixel point of the elements to be displayed, assigning the resulting Gaussian blurring value to each pixel point, and displaying the pixel point with the assigned value to obtain the element to be displayed;
for each blurring radius, choosing a pixel point from the element to be displayed as a central point, taking eight pixel points closest to the chosen pixel point within the blurring radius, obtaining weight values corresponding to the eight pixel points by use of the Gaussian blurring algorithm, multiplying the weight values of the eight pixel points with grayscale values corresponding to the eight pixel points to obtain final weight values, and summing up the final weigh values to obtain the Gaussian blurring value of the chosen pixel point; and
repeating the aforesaid process for all the pixel points to obtain the Gaussian blurring value of each of the pixel points, assigning the resulting Gaussian blurring value to each of the pixel points and displaying the pixel points with the assigned values to obtain the element to be displayed.

16. The non-transitory computed readable storage medium according to claim 15, wherein assigning die resulting Gaussian blurring value to each of the pixel points and displaying the pixel points with the assigned values comprises:
importing the resulting Gaussian blurring value into a static array;
calculating the number of the elements to be displayed in the newly created background;
importing Gaussian blurring values corresponding to the number of the elements to be displayed among the imported Gaussian blurring values into a dynamic array starting from a start position of the imported Gaussian blurring values that corresponds to a preset initial value of a horizontal scroll;
assigning data in the dynamic array to a chart control to form a chart;
converting the current chart into elements; and
displaying the elements in the background.

17. The non-transitory computed readable storage medium according to claim 13, wherein when the executable instructions are executed by the at least one processor further causes the at least one processor to: recover the elements when the elements are in an invisible or covered state.

18. The non-transitory computed readable storage medium according to claim 13, wherein before calling back the element displaying control, when the executable instructions are executed by the at least one processor further causes the at least one processor to:
snoop the time needed to generate the background through the element complex calculation; and
call back the element displaying control when the time needed to generate the background elapses.
